(19) United States
(12) Patent Application Publication
(10) Pub. No.: US 2006/0013735 A1
(43) Pub. Date: Jan. 19, 2006

(54) Ultraphobic surface having a multitude of reversibly producible hydrophilic and/or oleophilic areas

(76) Inventors: Joachim Engelking, Neustadt (DE); Karsten Reihs, Koln (DE); Eckhard Nordhoff, Berlin (DE); Martin Muller, Berlin (DE)

Correspondence Address: PERMAN & GREEN, 425 POST ROAD, FAIRFIELD, CT, 06824, US

(21) Appl. No.: 10/505,632

(22) PCT Filed: Feb. 24, 2003
(86) PCT No.: PCT/EP03/01859

§ 371 Date: Aug. 11, 2005

(30) Foreign Application Priority Data
Feb. 22, 2002 (DE) 102 07 615.4
Nov. 26, 2002 (DE) 102 55 276.2

(51) Int. Cl. B01L 3/00

(52) U.S. Cl. 422/99

(57) ABSTRACT

The invention relates to a planar structure, particularly a plate, having an ultraphobic surface on which the hydrophilic and/or oleophilic areas can be reversibly produced. The invention also relates to a planar structure comprising an ultraphobic surface provided with hydrophilic and/or oleophilic areas that are each completely surrounded by ultraphobic areas. The invention additionally relates to methods for reversibly producing hydrophilic and/or oleophilic areas on ultraphobic surfaces, to the deposition of liquid drops onto the inventive planar structure, and to the use of the inventive planar structure for conducting mass spectroscopic and/or optical analysis of aqueous liquids.

The present invention relates to a planar structure, particularly a plate, having an ultraphobic surface on which hydrophilic and/or oleophilic areas can be reversibly produced. The invention also relates to a planar structure conprising an ultraphobic surface provided with hydrophilic and/or oleophilic areas that are each completely surrounded by ultraphobic areas. The invention additionally relates to methods for reversibly producing hydrophilic and/or oleophilic areas ultraphobic surfaces, to the deposition of liquid drops onto the inventive planar structure and to the use of the inventive planar structure for conducting mass spectroscopic and/or optical analysis of samples.

Nowadays in the area of chemistry of active ingredients and also in biological research serial tests have to be performed to an increasing degree. In this case a large number of small liquid samples are mixed with different active ingredients in order to test the reaction of the individual active ingredient.

According to the state of the art the so-called microtiter plates or sample carriers are known, which provide a number of wells at regular distances. In WO 98/45406 and DE 196 28 928 sample carriers are described, which have a hydrophobia surface, which is moulded into the wells. These sample carriers have the disadvantage, that the wells have been placed in previously determined locations, so that the sample carriers cannot be adjusted individually for the respective experiment. Furthermore these sample carriers have the disadvantage that the comparatively large wells can only be moulded into the hydrophobic surface with a relatively high effort. From the German disclosure document DE 197 54 978 a sample carrier with a hydrophobic surface is known. Hydrophilic anchor areas are moulded into this hydrophobic surface. This state of the art additionally has the disadvantage that the hydrophilic anchor areas cannot be individually adapted to the particular experiment and are relatively difficult to produce.

Therefore the objective is to provide a planar structure, which does not have the disadvantages of the state of the art.

This task is accomplished, according to the invention, by a planar structure, with an ultraphobic surface on which hydrophilic and/or oleophilic areas can be reversibly produced.

A planar structure according to the invention is any formed body with an arbitrarily formed surface. Preferable however is a plate with a planar surface, especially preferable a sample carrier, which does not show any indentations. Most preferable the inventive planar structure is a film with an ultraphobic surface. Preferentially the surface of the inventive planar structure is essentially planar. That means the topography necessary for an ultraphobic surface does not show any microvolumes in which liquid can accumulate.

According to the invention the planar structure has an ultraphobic surface. An ultraphobic surface according to the invention is characterised by the fact that the contact angle of a water and/or oil drop, which is on the surface is larger than 150°, preferably larger than 160° and especially preferred larger than 170° and/or the roll off angle does not exceed 10°. The roll off angle is defined as the inclination of a basically plane but structured surface versus the horizontal where a still water and/or oil drop with a volume of 10 μl is moved due to gravity when the surface is tilted. Such ultraphobic surfaces are for instance disclosed in WO 98/23549, WO 96/04123, WO 96/21523, WO 99/10323, WO 00/39368, WO 00/39239, WO 00/39051, WO00/38845, and WO 96/34697, which are herewith introduced as reference and are accordingly part of the disclosure.

In a preferred design the ultraphobic surface shows a surface topography, where the spatial frequency of the individual Fourier components and their amplitude a(f) as expressed by the integral S(log(f))=a(f) calculated between the integration limits log(f₁/μm⁻¹)=−3 and log(f₂/μm⁻¹)=3 is at least 0.3 and which is made of a hydro-phobic or especially oleophobic material or provided with a permanent hydrophobic and/or especially stably oleophobised coating. Such an ultraphobic surface is described in the international patent application WO 00/39240, which is herewith introduced as reference and is therefore part of the disclosure.

Likewise hydrophilic and/or oleophilic areas are reversibly producible on the ultraphobic surface according to the invention. Hydrophilic and/or oleophilic areas in terms of the invention are areas, on which a water or oil drop can be deposited, i.e. a water or oil drop hanging on a pipetting system and being brought into contact with a hydrophilic and/or oleophilic area sticks to it and thereby detaches from the pipetting system. Preferably a water or oil drop with a volume of 10 μl takes a wetting angle <120°, preferably <110°, especially preferred <90°, and/or the roll off angle of this drop exceeds 10°. Furthermore these hydrophilic and/or oleophilic areas are reversibly producible according to the invention, so that they can be simply and fast removed after the respective application, e.g. measurement, and the corresponding planar structure is re-usable and the hydrophilic and/or oleophilic areas can be newly determined. The removal of the hydrophilic and/or oleophilic areas can be achieved e.g. by washing of the ultraphobic surface with a suitable solvent and/or warming the ultraphobic surface.

It was extremely surprising for the expert, that it is possible to provide ultraphobic planar structures with hydrophilic and/or oleophilic areas with the inventive planar structure, whereby the hydrophilic and/or oleophilic areas can be repeatedly configured for the respective application. The inventive planar structures are very easy to produce. With the inventive planar structure it is possible to conduct high quality mass spectrometric and/or optical analysis of e.g. biological material.

Especially interfering background signals are distinctly reduced in comparison to the state of the art by the inventive planar structures.

Preferably the hydrophilic and/or oleophilic areas of an ultraphobic area are completely surrounded by an ultraphobic area. By this design it is possible to deposit a drop of liquid at a well defined location and anchor it comparatively firm.

Furthermore preferred the hydrophilic and/or oleophilic areas are arranged according a well defined pattern on the ultraphobic surface.

The hydrophilic and/or oleophilic areas can have any form or size. Preferably however they have an area of 1 μm²-10 mm². On such an area a drop of liquid with a diameter of preferably 5 nm-5 mm can be deposited and anchored in a way that even hanging upside down it cannot detach itself from the inventive planar structure.

Preferably the hydrophilic area is at least one deposit on the ultraphobic surface at a time. This deposit can be liquid or solid. In the case of a liquid deposit the deposited substance must be preferably of low volatility. The deposits can for example be generated on the ultraphobic surface by an appropriate temperature of the ultraphobic surface or by substances, which are preferably dissolved and/or suspended preferably drop wise and the solvent or the liquid phase will be then evaporated. The ultraphobic surface must be wettable by the solvent or the liquid phase.

In a preferred design of the present invention the planar structure is provided with at least one means for preferably local cooling of the ultraphobic surface. Preferably the cooling is done in a way that the temperature on the ultraphobic surface is preferably locally confined <−5° C., especially preferred <−15° C. and a congealed substance is formed on the ultraphobic surface. The congealed substance is preferably formed by freezing of at least one component of the gas phase, which is in the vicinity of the ultraphobic surface. The congealed substance is preferably ice. Locally confined cooling is preferably achieved in a way that the cooling medium directly or indirectly touches the ultraphobic surface only punctually from underneath

Furthermore the inventive planar structure comprises at least one means by which the vapour pressure of at least one component of the gas phase, which is in the vicinity of the ultraphobic surface can be adjusted. Preferably this component is water vapour. The adjustment of the water vapour can for instance be done by a hood which is put over the ultraphobic surface and under which e.g. the concentration of the congealing component can be controlled.

A water or oil drop which is e.g. placed on the congealed substance, e.g. the ice crystals sticks to it, even though as a rule, especially when the area covered with the congealed substance under the liquid drop is very small, preferably ≦20% of the drop diameter, does not freeze. As soon as the temperature of the ultraphobic surface is raised to preferably >−5° C., especially preferred to >0° C. the surface in the hydrophilic and/or oleophilic areas becomes ultraphobic again. This temperature increase can be done either locally or over the total area of the surface. The ultraphobic surface is then cleaned e.g. by tilting whereby the cleaned drops of liquid roll off the surface. The ultraphobic surface cleaned in such way can be utilised again in a new application.

In another preferred design of the present invention the deposit is a solid or liquid substance, which is preferably dissolved and/or suspended on the ultraphobic surface, and applied preferably in forms of drops and the solvent and/or liquid phase is then evaporated. Preferably this substance is then in crystalline form on the ultraphobic surface. The solvent must be chosen in a way that it wets the ultraphobic surface and that the substance to be deposited is soluble in it, or at least suspensible.

Preferably the substance to be deposited i.e. the hydrophilic area is a MALDI-Matrix for conducting the so-called MALDI mass spectrometry, which is published e.g. by Nordhoff et. al., “MALDI-MS as a new method for the analysis of nucleic acid (DNA and RNA) with molecular masses up to 150,000 Dalton, Application of modern mass spectrometric methods to plant science research”, Oxford University press, (1966) page 86-101. This publication is herewith introduced as reference and therefore part of the disclosure. Preferred MALDI-Matrices are 3-hydroxypicolinic acid, α-cyano-4-Hydroxycinnamic acid, 2,5-dihydroxybenzoic acid, sinapinic acid, 2, 4, 6-trihydroxy-acetophenon, nitrobenzyl alcohol, nicotinic acid, ferulic acid, caffeine acid, 2-aminobenzoic acid, picolinic acid, 3-aminobenzoic acid, 2,3,4-trihydroxyacetophenon, 6-aza-2-thiothymidine, urea, succinic acid, adipic acid, malonic acid or its mixture. These MALDI-Matrices were dissolved e.g. in acetonitrile or in a acetonitrile water/mixture preferably at a mixing ration of 50:50-60:40 and applied as liquid, preferably as liquid drops on the ultraphobic surface. The solvent is evaporated there, so that the MALDI-Matrix exists preferably as crystalline structure, punctiform on the ultraphobic surface and there represents the hydrophilic and/or oleophilic areas upon which the samples to be analysed can be dispensed.

The samples to be analysed, which do not wet the ultraphobic surface, as a rule are dispensed as liquid preferably on the crystalline MALDI-Matrices and dissolve them preferably, at least partially. While the solvent evaporates, the MALDI-Matrix crystallises again and the samples to be analysed are incorporated into the MALDI-Matrix. These samples can then be analysed with a mass spectrometer.

In another preferred implementation the deposits on an ultraphobic surface is liquid, whereby the liquid wets the ultraphobic surface or must be dissolved in a solvent which wets the ultraphobic surface.

Preferably the liquid deposit is at least at room temperature sparsely volatile. This liquid is preferably also a MALDI-Matrix, for instance glycerol, upon which the analyte is dispensed.

The inventive planar structure is suitable for the analysis of any liquid, which is e.g. used in active ingredient research. Likewise preferred the inventive procedure is suitable for analysis of biomolecules and/or biological material, especially nucleic acids, nucleic acid analogues, Spiegelmers, aptamers, ribozyme, polypeptides, peptides or proteins. The inventive procedure is especially suited for mass spectroscopic and/or optical analysis of biomolecules. These applications are also objective of the present invention.

A biomolecule in terms of the present invention is any molecule which is made during the life cycle by any virus, single-cell or multi-cellular organism. Biomolecules contain at least one oxygen, nitrogen, sulfur and/or phosphorus atom. Examples for biomolecules are: Spiegelmers, aptamers, ribozyme, peptides, polypeptides, proteins, antibodies, nucleic acids, nucleic acid analogues, DNA, double-strand DNA, RNA, double-strand RNA/DNA, vitamins, carbohydrates, hormones, glycopeptides, glycoproteins, lipids, fatty acids and cholesterol.

Biological material in terms of the invention contains at least one biomolecule. It can also be a large amount of one and the same or different biomolecules. These can occur unorganised beside each other or can build functional units based on interactions. Examples for these are protein complexes, genomes, cell nuclei, ribosomes, cells, united cell structures, tissue or complete organisms.

An optical analysis in terms of the present invention is described in the German parallel application deposited at the German Patent and Trade Mark Office with the internal reference No. SY0028, which is introduced herewith and counts as part of the disclosure.

Another objective of the present invention is a planar structure with an ultraphobic surface with hydrophilic and/or oleophilic areas, which are in each case completely surrounded by ultraphobic areas.

A structure in terms of the invention is any formed body with an arbitrarily shaped surface. Preferably however the structure is a plate with a planar surface, especially preferred a sample carrier. Mostly preferred the inventive planar structure is a film, which has an ultraphobic surface. According to the invention the surface of the inventive structure is planar. That means it shows the topography necessary for an ultraphobic surface, but no microvolumes, which can collect fluid.

According to the invention the planar structure has an ultraphobic surface. An ultraphobic surface in terms of the invention is characterised in a way, that the contact angle of a water or oil drop, which rests on the surface, is >150°, preferably >160° and especially preferred >170° and/or the roll off angle does not exceed 10°. The roll off angle is defined as the inclination of a basically planar, but structured surface versus the horizontal, where a still water and/or oil drop with a volume of 10 μl is moved by gravity when the surface is tilted. Such ultraphobic surfaces are disclosed for example in WO 98/23549, WO 96/04123, WO 96/21 523, WO 99/1 0323, WO 00/39368, WO 00/39239, WO 00/39051, WO 00/38845 and WO 96/34697, which are introduced herewith as reference and therefore are part of the disclosure.

In a preferred implementation the ultraphobic surface shows a surface topography where the topological frequency of the individual Foyer components and there amplitude a(f) expressed by the integral S (log(f))=a(f). f, calculated between the integration limits log (f₁/pm¹)=−3 and log (f₂/pm¹)=3 is at least 0.3, and is made of hydrophobic or especially of oleophobic material or with a durable hydrophobised or especially durable oleophobised coating.

Such an ultraphobic surface is described in the International patent application WO 00/39240, which is introduced herewith as reference and thus becomes valid as part of the disclosure.

Hydrophilic and/or oleophilic areas in terms of the invention are areas on which water or oil drops can be deposited i.e. a water or oil drop hanging on a pipetting system which is brought into contact with a hydrophilic and/or oleophilic area sticks to it and therefore disconnects from the pipetting system. Preferably a water or oil drop with a volume of 10 μl assumes on the hydrophilic and/or oleophilic area a wetting angle of <120°, preferably <110°, especially preferred <90° and/or the roll off angle of this drop exceeds 10°.

It was extremely surprising for the expert and not to be expected, that it is possible to deposit liquid drops with the inventive structure comparatively firm as for example on a sample carrier. Because the structure is planar it can be easily manufactured. Planar surfaces have the advantage that the area with which the drop contacts the planar structure is relatively small, so that the contamination of the drop by substances on the surface and the thus produced error of measurement becomes minimized.

According to the invention hydrophilic and/or oleophilic, areas are completely surrounded by an ultraphobic area. By this design it is possible to deposit a drop at a well defined location and also anchor it comparatively firmly.

Furthermore the hydrophilic and/or oleophilic areas are arranged according to a well defined pattern on the ultraphobic surface.

The hydrophilic and/or oleophilic areas can have any arbitrary form or size. Preferably they have an area of 1 μm²-10 mm². On such an area a drop with a preferable diameter of 5 nm-5 mm can be deposited and preferably anchored in such a way, that it cannot detach from the inventive planar structure even when hanging upside down.

Preferably the hydrophilic and/or oleophilic areas are generated by a modification of the top level of the molecules of the ultraphobic surface. This modification is preferably achieved by a mechanical or thermal ablation by which preferably only one layer of molecules of the ultraphobic surface is removed. Furthermore the modification is done by thermal or chemical transformation of the ultraphobic surface, however without ablation as it is described in e.g. DE 199 10 809 A1 which herewith introduced as reference and thus becomes part of the disclosure. With this modification of the ultraphobic surface its layer thickness remains essentially unchanged.

The inventive planar structure is suitable for analysis of any liquid which is for instance known from active agents research. The inventive procedure is also preferably suited for analysis of biomolecules and/or biological material, especially nucleic acids, nucleic acid analogues, Spiegelmers, aptamers, ribozyme, polypeptides, peptides or proteins. The inventive procedure is especially suited for mass spectroscopic and/or optical analysis of biomolecules and/or biological materials. These applications are also the objective of the present invention.

In a preferred implementation form of both inventive planar structures the ultraphobic surface is formed as a disposable article.

For this implementation a multi-layered planar structure with a first layer with an ultraphobic surface and a carrier layer is suitable, where the first layer is reversibly attached and the maximum local deviation of the planar structure from the plane is 100 μm, especially preferred <20 μm.

This planar structure has the advantage, that the first layer with the ultraphobic surface can be detached from the carrier layer after one-time or repeated use and be replaced by a new first layer. By this it can be excluded that the first layer was contaminated by previous experiments. The first layer with an ultraphobic surface is especially cheap to produce as a disposable article. Since it has a planar structure as defined by the invention it can be used in all common mass spectrometric and /or optical analysis devices.

In a preferred implementation form of the planar structure the first layer is glued on the carrier layer.

Furthermore preferred is electrical conductivity between the first layer and the carrier layer. This implementation is especially advantageous for mass spectrometric analysis.

The preferred planar structure is an all-purpose device however preferably suited for mass spectrometric and/or optical analysis.

Another objective of the present invention is a procedure for depositing a drop on an inventive planar structure with an ultraphobic surface, which is cooled at least locally to a degree that a substance is deposited on the ultraphobic surface by the cooling.

Depositing in terms of the invention includes any way by which the expert deposits a liquid on an appropriate planar structure. Exemplary but not limiting would be pipetting and dispensing, as for instance with a pump. Preferably several drops would be deposited on one spot so that a larger drop is formed.

Preferably the deposited substance is ice, which forms from water vapour in the surrounding of the ultraphobic surface.

Preferably the cooling is done in a way, that the temperature on the ultraphobic surface is preferably locally confined to <−5° C., especially preferred <−15° C. and that based on the cooling deposits are formed on these spots of the ultraphobic surface. The locally confined cooling is preferably achieved by the ultraphobic surface touching the cooling medium only punctiform from underneath either directly or indirectly.

Furthermore preferred the vapour pressure of at least one component of the gas phase in the vicinity of the ultraphobic surface is adjusted with the inventive procedure. This component is preferably water vapour. For instance the adjustment of the water vapour can be done with a hood, which is put over the ultraphobic surface and thus the concentration of the congealing component can be controlled.

The inventive procedure is suited for the analysis of any liquid as it is e.g. known from active agent research. Likewise preferred the inventive procedure is suited for analysis of biomolecules and/or biological materials especially nucleic acids, nucleic acid analogues, Spiegelmers, aptamers, ribozyme, polypeptides, peptides or proteins. The inventive procedure is especially suited for the analysis of mass spectrometric and/or optical analysis of biomolecules and/or biological materials. These applications are likewise the objective of the present invention.

The procedure is simple and cost effective to perform. The planar structure can be reused. It is extremely surprising for the expert, that droplets as a rule do not freeze on the surface.

Another objective of the present invention is a method for depositing aqueous drops on the inventive planar structure.

With this method, a substance is preferably dispensed in dissolved and/or suspended form, preferably drop-wise and the liquid phase or the solvent which is wetting the ultraphobic surface is subsequently evaporated. On the residual hydrophilic deposit a drop of liquid can be deposited, which does not wet the ultraphobic surface.

Preferably the substance to be deposited i.e. the hydrophilic area is a MALDI-Matrix for conducting the so-called MALDI-mass spectrometry, which is described e.g. in Nordhoff et. al. “MALDI-MS as a new method for the analysis of nucleic acid (DNA and RNA) with molecular masses up to 150,000 Dalton, Application of modern mass spectrometric methods to plant science research”, Oxford University press, (1996) page 86-101.

Preferred MALDI-Matrices are 3-Hydroxypicolinic acid, α-Cyano-4-hydroxycinnamic acid, 2,5-dihydroxybenzoic acid, sinapinic acid, 2, 4, 6-trihydroxyacetophenon, nitrobenzyl alcohol, nicotinic acid, ferulic acid, caffeine acid, 2-aminobenzoic acid, picolinic acid, 3-aminobenzoic acid, 2,3,4-trihydroxyacetophenon, 6-aza-2-thiothymidine, urea, succinic acid, adipic acid, malonic acid or mixtures thereof. These MALDI-Matrices are dissolved e.g. in acetonitrile and applied on the ultraphobic surface, preferably as liquid drops und the solvent is evaporated on the spot, so that the MALDI-Matrix is existent preferably punctiform as crystalline structure on the ultraphobic surface and thus represents the hydrophilic and/or oleophilic areas upon which the samples to be analysed can be dispensed.

The samples to be analysed which do not wet the ultraphobic surface are usually dispensed as liquid on the crystalline MALDI-Matrices and preferably dissolve it, at least partially. While the solvent is then again evaporated, the MALDI-Matrix crystallizes again and the samples to be analysed are incorporated into the MALDI-Matrix.

Likewise preferred, substances with specific or unspecific binding capacity for biological materials are preferably suited as matter to be deposited.

Another objective of the present invention is a procedure for depositing a drop on an inventive planar structure with an ultraphobic surface, where on the ultraphobic surface a liquid is deposited, which wets the surface and before it is evaporated, on it at least one drop which does not wet the ultraphobic surface is deposited.

With surfaces, on which a drop assumes a wetting angle >150° there is preferably a liquid used as wetting liquid, which has a surface tension lower than water and which is preferably at least partially mixable with water. Especially preferred the wetting liquid is acetone, acetonitrile or alcohol, preferably isopropanol or mixtures of them. These wetting liquids contain preferably a water content of <50% (vol.), especially preferred <30% (vol.) and most preferred <10% (vol.).

With surfaces where an oil drop assumes a wetting angle of >150° a liquid is used as wetting liquid, which has a lower surface tension than oil. Especially preferred acetone is used.

Preferably the wetting fluid is dispensed as drop on the ultraphobic surface, where the number of wetting drops is ≧ than the number of the drops to be deposited on the ultraphobic surface. Preferably the volume of the wetting drops is 10⁻¹-10⁻⁹ times of the volume of the drops to be deposited, where the proportion immediately before depositing the drop is critical, especially because many liquids wetting an ultraphobic surface have a high vapour pressure and evaporate rapidly.

The ultraphobic surface can be cleaned by removing all liquid content and re-used. The ultraphobic surface then does not contain any more hydrophilic and/or oleophilic areas.

The inventive procedure is suitable for analysis of any liquid, as they are known e.g. for active agent research. Likewise preferred the inventive procedure is suited for analysis of biomolecules and/or biological materials especially nucleic acids, nucleic acid analogues, Spiegelmers, aptamers, ribozyme, polypeptides, peptides or proteins. Especially suitable is the inventive procedure for mass spectroscopic and/or optical analysis of biomolecules or biological materials. These applications are likewise the objective of the present invention.

It was extremely surprising for the expert and not to be expected that it is possible with the inventive procedure to immobilize a water drop with a solvent drop on an ultraphobic surface, even though the volume of the water drop exceeds the volume of the solvent drop by 10¹-10⁹ times.

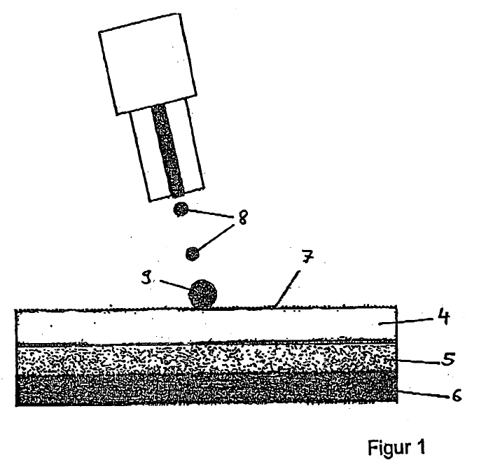

In the following the invention is explained by means of FIGS. 1-5. These explanations are only exemplary and do not constrict the general thought of the invention.

FIG. 1 shows an implementation of the inventive planar structure with cooling.

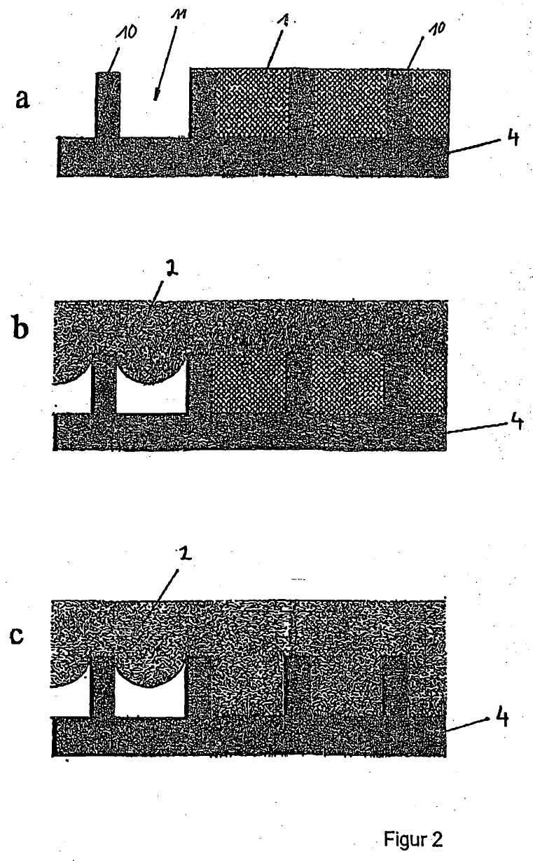

FIG. 2 shows an implementation of the inventive planar structure with a wetting liquid.

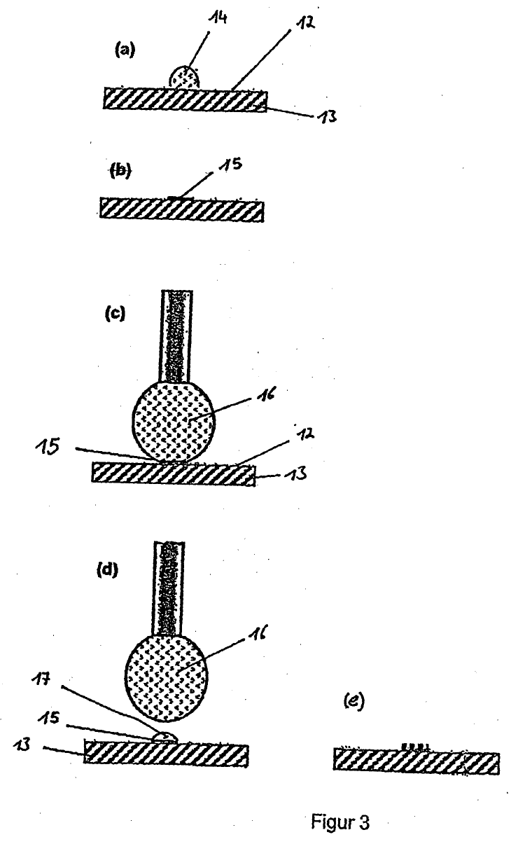

FIG. 3 shows how a hydrophilic area is generated by crystallization.

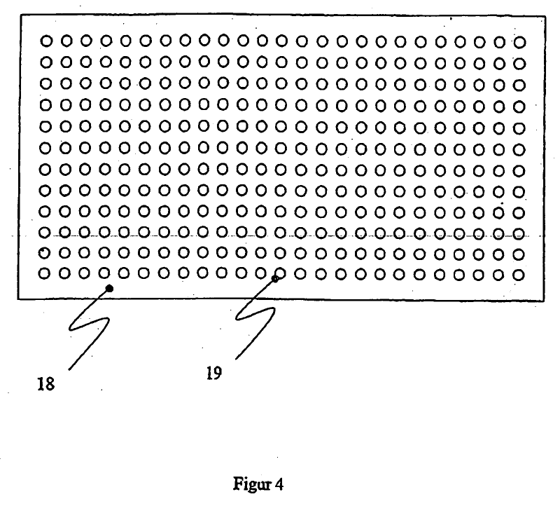

FIG. 4 shows an ultraphobic surface with a multitude of hydrophilic areas.

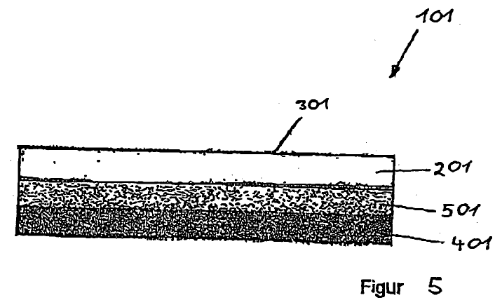

FIG. 5 shows a planar structure with an ultraphobic surface as a single use article.

FIG. 1 shows an inventive planar structure with cooling. In the present case the planar structure is a film 4 with an ultraphobic surface on which a water drop at room temperature assumes a wetting angle of 174° and the roll off angle is <10°. The film 4 is cooled with a Peltier element 5 and a flowthrough cooler 6. The Peltier element is connected to a temperature sensor (not shown) with which the temperature of the ultraphobic surface is controlled to <−16° C. At these temperatures a thin layer of frost 7 is formed. A water drop 8, which is dispensed on the ultraphobic surface with a speed of <4 m/sec sticks to it and does not roll off. In the present case several drops 8 were dispensed on the ultraphobic surface, so that a larger drop is formed. With a thin layer of frost this drop does not freeze and shows a wetting angle of about 120°.

FIG. 2a shows an implementation of the inventive procedure with a wetting liquid. The wetting fluid 1 is dispensed in form of a drop on a ultraphobic surface 4, on which a water drop assume a wetting angle of 174° in the absence of a wetting liquid and the roll off angle is <10°. As is known ultraphobic surfaces display a certain topography, which are symbolized here by the bulge 10 and the bulges 11 in between. The ultraphobic surface is wetted by the wetting liquid 1, in the present case acetone. On this wetted part of the ultraphobic surface 4 then a water drop 2 is dispensed (compare with FIG. 2b), which is much larger than drop 2 with which the ultraphobic surface was wetted.

The water drop is thus firmly deposited on the ultraphobic surface. The arrows in FIG. 2b indicate the diffusion between the wetting liquid 1 and the water drop 2. FIG. 2c shows the situation after some time has passed. The water has mixed with the acetone, so that the ultraphobic surface is wetted on certain spots by this mixture. This wetting remains however confined on the originally wetted area by acetone.

FIG. 3 shows how hydrophilic and/or oleophilic areas on the ultraphobic surface are produced by the deposit. In FIG. 3a a cut-out of the planar surface 12 of a sample carrier 13 is displayed. The surface is ultraphobic, so that a 10 μl water drop shows a wetting angle of >174° and a roll off angle of <10°. On the ultraphobic surface a drop 14 is deposited, which wets it and in which a substance X is dissolved or suspended. After depositing drop 14 the solvent is evaporated and the crystalline deposit 15 is formed (FIG. 3b), which is composed essentially of X and as the case may be of residues of the solvent. The substance X can be for example a MALDI-Matrix. The area of deposit 15 results from the size of the drop 14 and the chosen solvent and by this can be adjusted very exactly. The expert realizes, that the ultraphobic surface consists of several deposits 15, which are arranged at a certain lateral distance and preferably in a defined grid pattern on the ultraphobic surface. The deposit 15 represents a hydrophilic and/or oleophilic area, which is completely surrounded by ultraphobic areas. The deposit 15 can be removed after the individual experiment from the ultraphobic surface, so that the latter can be re-used. The cleaning of the ultraphobic surface can for instance be accomplished with a solvent.

FIG. 3c shows the further use of deposit 15, which represents a hydrophilic and/or oleophilic area. One drop 16, which does not wet the ultraphobic surface and which hangs on a pipette or a rod, is brought into contact with the hydrophilic area 15. The drop contains for instance biological material. By the ultraphobicity of the surface 12, which completely surrounds the hydrophilic area, the wetting angle of the drop 16 is so large, that it touches only the hydrophilic area and not the ultraphobic area 12. This configuration has the advantage, that the drop 16 is not being contaminated by the ultraphobic surface 12 or by substances from the drop 16 which are transported for example by adsorption to the ultraphobic surface and therefore are not any more available for the following analysis. FIG. 4d shows the situation after the drop 16 has been lifted from the hydrophilic area. A small portion 17 of the drop 16 remains attached on the hydrophilic area 15. The volume of liquid 17, which is attached on the hydrophilic area 15 depends from its respective area and is much smaller than the volume of drop 16, so that the dispensing operation with one drop 16 can be repeated several times. With identical area size of the hydrophilic areas 15 and same amount of liquid 16 always the same amount of liquid 17 adheres to the hydrophilic areas 15, with a small error. Since liquid 17 likewise never comes into contact with the ultraphobic surface it will also never be contaminated or no substances become transferred from liquid 17 unto the ultraphobic surface 12. The liquid 17 can afterwards be analysed either optical or by mass spectrometry. For this additional reagents can be added to liquid 17. This procedure is illustrated in FIG. 3e.

The inventive device has the advantage that the samples 17 to be analysed are not being contaminated during analysis, so that for instance mass spectra or fluorescence measurements or fluorescence spectra of high quality can be registered from samples 17 with a very low background signal.

FIG. 4 shows an ultraphobic surface 18 with a multitude of hydrophilic areas 19, which are completely surrounded by the ultraphobic areas.

FIG. 5 shows the planar structure 101, that consists of a first layer 201 with an ultraphobic surface 301 and a carrier layer 401. The first layer 201 is fixed on the carrier layer with an adhesive layer 501. The expert can see that the adhesive layer must not necessarily be present. The adhesive layer consists of an electrically conductive material, so that an electrical contact between the first layer 201 and the carrier material exists.

1. Planar structure, particularly a plate, having an ultraphobic surface on which the hydrophilic and/or oleophilic areas can be reversibly produced.

2. Planar structure according to claim 1, characterized in that the hydrophilic and/or oleophilic areas are each completely surrounded by ultraphobic areas.

3. Planar structure according to claim 1, characterized in that the hydrophilic and/or oleophilic areas are at least partially arranged according to a defined pattern on the surface.

4. Planar structure according to claim 1, characterized in that the ultraphobic surface has a surface topography, where the topological frequency f of the indivisual Fourier components and their amplitudes a(f) expressed by the integral S(log (f))=a(f)*f calculated between the integration limits log (f₁μm⁻¹)=−3 and log (f₂μm⁻¹)=−3, is at least 0.3 and which is made of ultraphobic polymers or durable ultraphobic materials and/or with a coating made of a hydrophobic and/or oleophobic material.

5. Planar structure according to claim 1, characterised in that the hydrophilic and/or oleophilic areas each have an area of 1 μm²-10 mm².

6. Planar structure according to claim 1, characterized in that the hydrophilic area is at least a deposit, preferably a congealed substance on the surface.

7. Planar structure according to claim 1, characterised in that it has means for preferably local cooling of the ultraphobic surface.

8. Planar structure according to claim 7, characterised in that the ultraphobic surface can be cooled to temperatures of <−5° C., preferably to <−15° C.

9. Planar structure according to claim 7, characterised in that the congealed substance is at least one component of the gas phase, which is in the vicinity of the ultraphobic surface and which freezes on the ultraphobic surface.

10. Planar structure according to claim 6, characterised in that the congealing substance is at least ice, preferably ice crystals and the component of the gas phase is at least water vapor.

11. Planar structure according to claim 6, characterised in that it has means for adjustment of the vapour pressure of at least one component of the gase phase, which is in the vicinity of the ultraphobic surface.

12. Planar structure according to claim 6, thus characterised that the deposit is a substance, which was dispensed in dissolved and/or suspended form on the ultraphobic surface and the liquid phase or solvent of which was evaporated.

13. Planar structure according to claim 12, characterised in that the liquid phase or the solvent wets the ultraphobic surface.

14. Planar structure according to claim 6, characterised in that the congealed substance is a MALDI-Matrix and/or biological material.

15. Planar structure with an ultraphobic surface with hydrophilic and/or oleophilic areas, which are each completely surrounded by ultraphobic surfaces.

16. Planar structure according to claim 15, characterised in that the hydrophilic and/or oleophilic areas are at least partially arranged according to a defined pattern on the surface.

17. Planar structure according to claim 15, characterised in that the ultraphobic surface has a surface topography, where the topological frequency f of the individual Fourier components and their amplitudes a(f) expressed by the integral S(log (f))=a(f)*f calculated between the integration limits log (f₁μm⁻¹)=−3 and log (f₂μm⁻¹)=−3, is at least 0.3 and which consists of ultraphobic polymers or durable ultraphobic material and/or is provided with a coating of hydrophobic and/or oleophobic material.

18. Planar structure according to claim 15, characterised in that the hydrophilic and/or oleophilic areas each have a surface of 1 μm²-10 mm².

19. Planar structure according to claim 15, characterised in that the surface of which is essentially ultraphobic and in that the hydrophilic and/or oleophilic areas are generated by a modification of the top molecule layer of the ultraphobic surface.

20. Planar structure according to claim 1 with a first layer with an ultraphobic surface and a carrier layer, characterised in that the first layer is reversibly applied on a carrier layer and the maximum local deviation of the planar structure from the plane is <100 μm.

21. Planar structure according to claim 20, characterised in that the first layer is glued on the carrier layer.

22. Planar structure according to claim 20, characterised in that between the first layer and the carrier layer an electrical contact is maintained.

23. Planar structure according to claim 20, characterised in that the ultraphobic surface has at least one hydrophilic area.

24. Planar structure according to claim 20, characterised in that the layer is a disposable.

25. Procedure for depositing a drop on a planar structure according to claim 6, characterised in that the ultraphobic surface is at least so cooled, that by cooling at least one substance congeals locally on the ultraphobic surface and the drop is deposited on the congealed substance.

26. Procedure according to claim 20, characterised in the congealed substance is ice.

27. Procedure according to claim 20, characterised in that several drops are deposited on one spot and thereby a larger drop is produced.

28. Procedure for producing a planar structure according to claim 6, characterised in that a substance in preferably dissolved and/or suspended form is dispensed preferably as drops and in that the liquid phase or the solvent wetting the ultraphobic surface is subsequently evaporated.

29. Procedure according to claim 23, characterised in that the substance is a MALDI-Matrix.

30. Procedure according to claim 23 characterised in that the substance is suitable for specific or unspecific binding of biological material.

31. Procedure for depositing a drop according to claim 1, characterised in that on the ultraphobic surface a liquid a liquid which is wetting it is deposited and before the liquid is evaporated on it at least one drop of a liquid, which is not wetting the ultraphobic surface, is deposited.

32. Procedure according to claim 26, characterised in that the wetting liquid is deposited in form of a drop on the ultraphobic surface.

33. Procedure according to claim 27, characterised in that the volume of the drop is much smaller than that of drop.

34. Procedure according to claim 26, characterised in that the liquid has a lower surface tension than water and is preferably soluble in the liquid of drop.

35. Procedure according to claim 26, characterised in that the liquid is acetone, acetonitrile, alcohol and especially preferred isopropanol.

36. Procedure according to claim 26, characterised in that the drop of liquid contains biological material.

37. Use of the planar structure according to claim 1 and of the procedures 25-36 for mass spectroscopic and/or optical analysis or for DNA sequencing by means of the peptide nucleic acid method (PNA).
